(19) United States
(12) Patent Application Publication
(10) Pub. No.: US 2009/0135106 A1
(43) Pub. Date: May 28, 2009

(54) ORGANIC LIGHT EMITTING DISPLAY AND DRIVING METHOD FOR THE SAME

(76) Inventors: Hyo-Jin Lee, Suwon-si (KR); Il-Han Lee, Suwon-si (KR); Yoon Kang, Suwon-si (KR)

Correspondence Address: CHRISTIE, PARKER & HALE, LLP, PO BOX 7068, PASADENA, CA, 91109-7068, US

(21) Appl. No.: 12/195,337

(22) Filed: Aug. 20, 2008

(30) Foreign Application Priority Data
Nov. 28, 2007 (KR) 10-2007-0122194

(51) Int. Cl. G09G 3/30

(52) U.S. Cl. 345/76

(57) ABSTRACT

An organic light emitting display and a driving method for the same for preventing picture playback disruption during the playback of a moving picture. An organic light emitting display includes: a display region including a plurality of pixels for displaying an image; a frame memory for storing image signals of the image; a data driver for receiving the image signals to generate data signals; a scan driver for generating scan signals; and a controller for controlling the frame memory to store the image signals and to transfer the image signals stored in the frame memory to the data driver. The controller controls the frame memory to store the image signals for at least two horizontal synchronization periods before they are transferred to the data driver.

### CROSS-REFERENCE TO RELATED APPLICATIONS

This application claims priority to and the benefit of Korean Patent Application No. 10-2007-0122194, filed on Nov. 28, 2007 in the Korean Intellectual Property Office, the entire content of which is incorporated herein by reference.

### BACKGROUND OF THE INVENTION

1. Field of the Invention

The present invention relates to an organic light emitting display and a driving method for the same.

2. Discussion of Related Art

Recently, various flat panel display devices with reduced weight and volume in comparison to a cathode ray tube display have been developed. Some examples of the flat panel display devices are liquid crystal display (LCD), field emission display (FED), plasma display panel (PDP) and organic light emitting display, etc.

Organic light emitting display displays images by generating light using organic light emitting diodes by re-coupling of electrons and holes.

As a result of the organic light emitting diode displays various advantages such as excellent color reproduction and thin thickness, etc., the market for the organic light emitting displays has been largely expanded to include PDA and MP3 Player applications, etc., in addition to cellular phone applications.

To reproduce a moving picture, the organic light emitting display stores the image signals for a moving picture transferred from an external source in a frame memory. The organic light emitting display generates data signals by using the stored image signals to display an image of the moving picture.

Here, as the image signals already stored in the frame memory are transferred to a data driver, new image signals are transferred from the external source to the frame memory.

However, due to various external factors, when the transfer of the image signals from the frame memory to the data driver is delayed, the next image signals may not be transferred to the frame memory. If the image signals are delayed, problems arise in that a picture appears to be broken during the reproduction of the moving picture.

### SUMMARY OF THE INVENTION

Therefore, embodiments of the present invention provide an organic light emitting display and a driving method for the same for preventing picture playback disruption during the playback of a moving picture.

According to a first embodiment of the present invention, there is provided an organic light emitting display including: a display region configured to receive data signals and scan signals through a plurality of data lines and a plurality of scan lines for displaying an image; a frame memory for storing image signals of the image; a data driver coupled to the plurality of data lines and configured to receive the image signals to generate the data signals; a scan driver coupled to the plurality of scan lines and configured to generate the scan signals; and a controller for controlling the frame memory to store the image signals and to transfer the image signals stored in the frame memory to the data driver. The controller is configured to store the image signals in the frame memory for at least two horizontal synchronization time periods from a time when the image signals are stored to a time when the image signals are transferred to the data driver.

According to another embodiment, a driving method for an organic light emitting display is provided. Image signals input from an external source are stored in a frame memory in response to control signals, and the image signals are transferred from the frame memory to a data driver after at least two horizontal synchronization periods after the frame memory has received the control signals.

According to a third embodiment, a driving method for an organic light emitting display is provided. Control signals are provided to control a frame memory to store image signals input from an external source in the frame memory, and the image signals are transferred from the frame memory to a data driver. A ratio of an input data rate and an output data rate of the frame memory is not fixed.

### BRIEF DESCRIPTION OF THE DRAWINGS

The accompanying drawings, together with the specification, illustrate exemplary embodiments of the present invention, and, together with the description, serve to explain the principles of the embodiments of the present invention.

FIG. 1 is a block diagram showing a structure of an organic light emitting display according to an embodiment of the present invention;

FIG. 2 is a timing diagram showing waveforms of input and output signals from a controller of FIG. 1; and

FIG. 3 is a circuit diagram showing a structure of a pixel of FIG. 1.

### DETAILED DESCRIPTION OF EMBODIMENTS

Hereinafter, certain exemplary embodiments according to the present invention will be described with reference to the accompanying drawings. Here, when a first element is described as being coupled to a second element, the first element may be directly coupled to the second element, or alternatively may be indirectly coupled to the second element via a third element. Further, some of the elements that are not essential to the complete understanding of the invention are omitted for clarity. Also, like reference numerals refer to like elements throughout.

Hereinafter, exemplary embodiments of the present invention will be described with reference to the accompanying drawings.

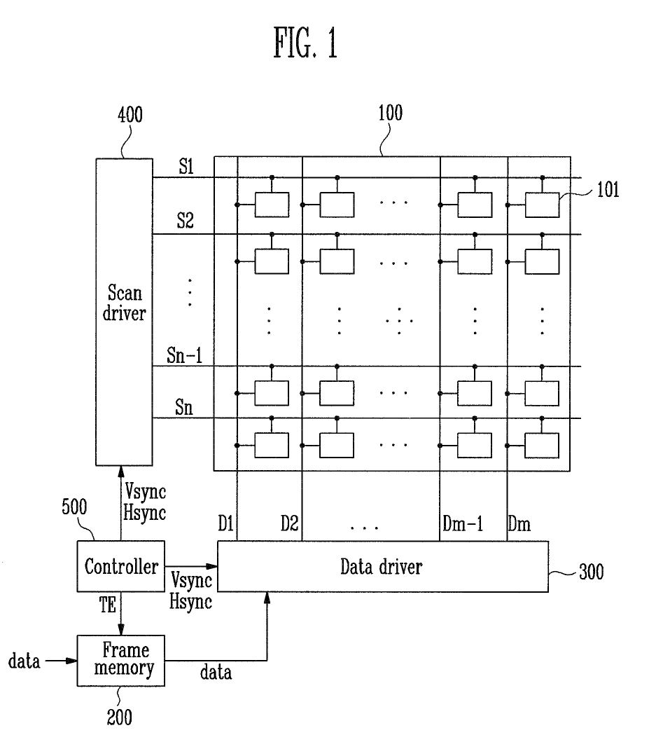

FIG. 1 is a block diagram showing a structure of an organic light emitting display according to an embodiment of the present invention. Referring to FIG. 1, the organic light emitting display includes a display region 100, a frame memory 200, a data driver 300, a scan driver 400, and a controller 500.

The display region 100 includes a plurality of pixels 101. Each pixel 101 includes an organic light diode (not shown) for emitting light corresponding to a current flow. Also, the display region 100 includes n scan lines S1, S2, . . . , Sn-1, and Sn that are spaced apart from each other and extend in a row direction to transfer scan signals, and m data lines D1, D2, . . . , Dm-1, and Dm that are spaced apart from each other and extend in a column direction to transfer data signals.

The display region 100 as described above is driven by receiving power from a first power supply ELVDD and a second power supply ELVSS from external sources. Therefore, the display region 100 displays an image by means of emitting light from the organic light emitting diodes corresponding to the scan signals, the data signals, the first power supply ELVDD and the second power supply ELVSS.

The frame memory 200 stores image signals to be input in one frame from the external source corresponding to control signals TE and then transfers the stored image signals data to the data driver 300.

The data driver 300 applies the data signals to the display region 100. The data driver 300 as described above receives the image signals having red, blue and green components from the frame memory 200 to generate the data signals. The data driver 300 is coupled to the data lines D1, D2, . . . , Dm-1, and Dm of the display region 100 to apply the generated data signals to the display region 100.

The scan driver 400 applies scan signals to the display region 100. The scan driver 400 as described above generates scan signals. The scan driver 400 is coupled to the scan lines S1, S2, . . . , Sn-1, and Sn to transfer the generated scan signals to a specific row of the scan lines S1, S2, . . . , Sn-1, and Sn. The pixels 101 receive the scan signals through scan lines and the data signals output from the data driver 300 through data lines. Therefore, driving currents are generated in the pixels 101 that receives the data signals, and the driving currents flow to the organic light emitting diodes.

The controller 500 controls the frame memory 200 using the control signals TE to store the image signals transferred from the external source in the frame memory 200 as image signals data. Also, the controller 500 controls the transfer of the image signals data stored in the frame memory 200 to the data driver 300 and then controls the data driver 300 to generate the data signals. Also, the controller 500 outputs the control signals such as vertical synchronization signals Vsync and horizontal synchronization signals Hsync, for controlling the operations of the data driver 300 and the scan driver 400.

FIG. 2 is a timing diagram that illustrates waveforms of input and output signals from the controller 500 of FIG. 1. Referring to FIG. 2, the controller 500 outputs horizontal synchronization signals Hsync and vertical synchronization signals Vsync. The horizontal synchronization signals Hsync provide timing information for each row of pixels 101 of the display region 100. The vertical synchronization signals Vsync provide timing information for each frame displayed in the display region 100. Also, the controller 500 generates control signals TE for controlling the transfer of the image signals data input from the external source to the frame memory 200.

The image signals data stored in the frame memory 200 are transferred to a data driver 300 corresponding to the horizontal synchronization signals Hsync and the vertical synchronization signals Vsync. For example, for each vertical synchronization signal Vsync and each horizontal synchronization signal Hsync input to the data driver, the image signals data corresponding to one row of pixels 101 of the display region 100 are extracted form the frame memory 200 to be transferred to the data driver 300. When the next horizontal synchronization signal Hsync is input, the image signals data corresponding to the next row of pixels 101 of the display region 100 are extracted from the frame memory 200 to be transferred to the data driver 300. After the image signals data corresponding to one frame are transferred to all the rows of pixels 101, the next vertical synchronization signal Vsync and one horizontal synchronization signal Hsync are input to the data driver 300. Accordingly, the image signals data corresponding to a second frame are transferred to the data driver 300 through the same operation as explained above.

Here, the controller 500 transfers the control signals TE to the frame memory 200 in order to synchronize the frame memory 200 with the vertical synchronization signals Vsync. In other words, when the data driver 300 receives the image signals from the frame memory 200, the frame memory 200 also starts to receive the image signals data from the external source. Since the vertical synchronization signals Vsync are transferred frame by frame (i.e., in frame units), the control signals TE synchronized to the vertical synchronization signals Vsync are also transferred frame by frame. In other words, the frame memory 200 receives and stores the image signals data in unit of frame units.

However, if the image signals data start to be transferred from the frame memory 200 to the data driver 300 after one horizontal synchronization time period (i.e., time required for inputting the next horizontal synchronization signal Hsync after a previous horizontal synchronization signal Hsync is input) after the control signals TE are transferred to the frame memory 200, a phenomenon of picture playback disruption may occur.

The reason is that one horizontal synchronization time period is required for storing the image signals data transferred from the external source for one row of pixels 101 in the frame memory 200, and another horizontal synchronization time period is required for transferring the image signals data from the frame memory 200 to the data driver 300. In other words, a total of two horizontal synchronization time periods are required to transfer the image signals data from an external source to the data driver 300. However, the time taken in transferring the image signals data from the external source to the frame memory 200 may be delayed due to various environmental factors. For example, if the image signals data set to be transferred to the data driver 300 is not transferred after one horizontal synchronization time period elapses after the image signals data are stored in the frame memory 200, the transfer of the image signals data is delayed so that the frame memory 200 does not store the next image signal data in time. As a result, the image signals data for the next row of pixels 101 transferred to the data driver 300 may contain erroneous image signals. Thereby, the display region 100 may display a broken picture.

Embodiments of the present invention allow the image signals data to be stored in the frame memory 200 for at least two horizontal synchronization time periods before the image signals data are transferred to the data driver 300. Therefore, since the image signals data are delayed in the frame memory 200 as described above, it is possible to secure sufficient time required for storing new image signals data in the frame memory 200. Therefore, it is possible to prevent or reduce a phenomenon that a picture appears to be broken during the reproduction of a moving picture by the display region 100.

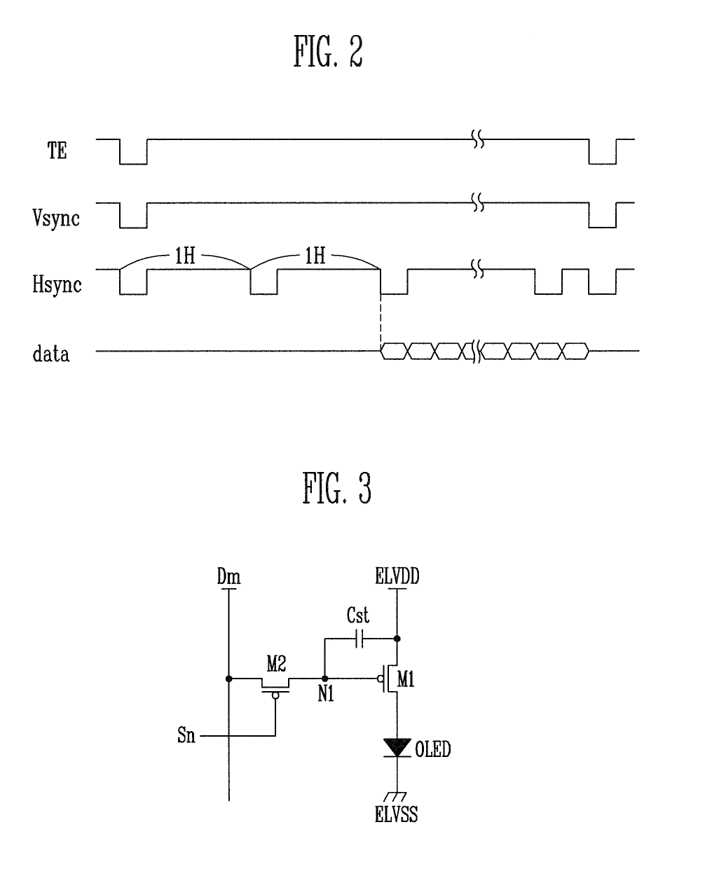

FIG. 3 is a circuit schematic diagram showing a structure of a pixel 101 of FIG. 1. Referring to FIG. 3, the pixel 101 includes a first transistor M1, a second transistor M2, a capacitor Cst, and an organic light emitting diode (OLED).

A source of the first transistor M1 is coupled to a first power supply ELVDD, a drain thereof is coupled to an anode electrode of the OLED, and a gate thereof is coupled to a first node N1. Therefore, the first transistor M1 determines the amount of current flowing from the source to the drain corresponding to the voltage of the first node N1.

A source of the second transistor M2 is coupled to a data line Dm, a drain thereof is coupled to the first node N1, and a gate thereof is coupled to a scan line Sn. Therefore, the second transistor M2 allows the data signal transmitted on the data line Dm to be transferred to the first node N1 corresponding to the scan signal transferred to its gate through the scan line Sn.

A first electrode of the capacitor Cst is coupled to the first power supply ELVDD, and a second electrode thereof is coupled to the first node N1. Therefore, the capacitor Cst maintains the voltage of the first node N1 and thus, allows the amount of current flowing from the source of the first transistor M1 to the drain thereof to be substantially constant.

The OLED includes an anode electrode, a cathode electrode, and a light-emitting layer formed between the anode electrode and the cathode electrode. The anode electrode of the OLED as described above is coupled to the drain of the first transistor M1, and the cathode electrode thereof is coupled to the second power supply ELVSS. The OLED emits light when a current flows from the anode electrode to the cathode electrode.

With the organic light emitting display and a driving method for the same according to the embodiments of the present invention, image signals are transferred to a data driver after sufficient time has elapsed from a time when the image signals are stored in a frame memory. Therefore, the image signals are stored in the frame memory for a sufficient time, making it possible to prevent or reduce picture playback disruption during the reproduction of a moving picture. In other words, a ratio of an input data rate and an output data rate of the frame memory is not fixed over a period of time. However, over the period of time, an average input data rate is equal to an average output data rate. While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display comprising:
a display region comprising a plurality of pixels configured to receive data signals and scan signals through a plurality of data lines and a plurality of scan lines for displaying an image;
a frame memory for storing image signals for the image;
a data driver coupled to the plurality of data lines and configured to receive the image signals to generate the data signals;
a scan driver coupled to the plurality of scan lines and configured to generate the scan signals; and
a controller for controlling the frame memory to store the image signals and to transfer the image signals stored in the frame memory to the data driver,
wherein the controller is configured to store the image signals in the frame memory for at least two horizontal synchronization time periods from a time when the image signals are stored to a time when the image signals are transferred to the data driver.

2. The organic light emitting display as claimed in claim 1,
wherein the controller is configured to output control signals for controlling the time when the image signals are input to the frame memory, vertical synchronization signals for providing timing information of one frame, and horizontal synchronization signals for providing timing information of data signals that are input to one row of the pixels in the display region, and
wherein the controls signals and the vertical synchronization signals are synchronized with each other.

3. The organic light emitting display as claimed in claim 2, wherein the data driver is configured to receive the image signals after at least two horizontal synchronization time periods after the controls signals are input to the frame memory.

4. A driving method for an organic light emitting display comprising:
storing image signals input from an external source in a frame memory in response to control signals; and
transferring the image signals from the frame memory to a data driver after at least two horizontal synchronization time periods after the frame memory receives the control signals.

5. The driving method for the organic light emitting display as claimed in claim 4, wherein the control signals are synchronized with vertical synchronization signals.

6. A driving method for an organic light emitting display comprising:
providing control signals to control a frame memory to store image signals input from an external source in the frame memory; and
transferring the image signals from the frame memory to a data driver,
wherein a ratio of an input data rate and an output data rate of the frame memory is not fixed.

7. The driving method for the organic light emitting display as claimed in claim 6, wherein the control signals are synchronized with vertical synchronization signals.

8. The driving method for the organic light emitting display as claimed in 6, wherein an average input data rate is equal to an average output data rate.
